(19) United States
(12) Patent Application Publication
(10) Pub. No.: US 2015/0187391 A1
(43) Pub. Date: Jul. 2, 2015

(54) BASE FOR HARD DISK DRIVE AND HARD DISK DRIVE INCLUDING THE SAME

(71) Applicant: SAMSUNG ELECTRO-MECHANICS CO., LTD., Suwon-Si (KR)

(72) Inventors: Viatcheslav Smirnov, Suwon-Si (KR); Jae Hwan Kwak, Suwon-Si (KR); Hyun Chul Lee, Suwon-Si (KR); Joo Young Lee, Suwon-Si (KR)

(73) Assignee: SAMSUNG ELECTRO-MECHANICS CO., LTD., Suwon-Si (KR)

(21) Appl. No.: 14/267,296

(22) Filed: May 1, 2014

(30) Foreign Application Priority Data
Dec. 30, 2013 (KR) 10-2013-0167413

(51) Int. Cl. G11B 33/02; G11B 19/20

(52) U.S. Cl. CPC G11B 33/022; G11B 19/2009

(57) ABSTRACT

A base may include: a base frame formed by plastic working of a steel sheet; a motor installation portion formed by depressing one portion of the base frame so that the depressed outer portion protrudes from a bottom surface of the base frame; and an additional reinforcement member provided on an outer side of a side wall surface of the motor installation portion protruding from the bottom surface of the base frame.

### CROSS-REFERENCE TO RELATED APPLICATION

This application claims the benefit of Korean Patent Application No. 10-2013-0167413 filed on Dec. 30, 2013, with the Korean Intellectual Property Office, the disclosure of which is incorporated herein by reference.

### BACKGROUND

The present disclosure relates to a base for a hard disk drive, and more particularly to a base for a hard disk drive including a reinforcement member coupled to a motor installation portion of a base frame.

A hard disk drive (HDD), a computer information storage device, reads data from a disk or writes data to a disk using a magnetic head.

In such a hard disk drive, a base is provided with a head driver, that is, a head stack assembly (HSA), capable of altering a position of the magnetic head relative to the disk. The magnetic head performs its functions while being moved to a desired position, relative to the disk, in a state in which it is suspended above a surface of the disk by the head driver at a predetermined height.

According to the related art, in manufacturing a base provided in a hard disk drive, a post-processing scheme of die-casting aluminum (Al) and then removing flash, or the like, generated during the die-casting process has been used.

However, in the die-casting scheme according to the related art, since a process of injecting molten aluminum (Al) for the casting thereof to form a member is performed, high degrees of temperature and pressure are required, such that a large amount of energy is required in the process and a processing time may be increased.

Further, in terms of a lifespan of a die-casting mold, there is a limitation in terms of in manufacturing a large number of hard drive bases using a single mold, and a base manufactured by the die-casting process may have poor dimensional precision.

Therefore, in order to solve problems in the die-casting process, such a hard drive base has been manufactured using a pressing process. However, in the case of manufacturing a hard drive base using such a pressing process, such a hard drive base inevitably has a uniform thickness due to a process of pressing and bending a plate.

Since a pressed base may be manufactured by performing a single process such as a pressing process, or the like, on a steel sheet, there are many advantages in that the pressed hard drive base may be simply manufactured may be relatively lightweight, or the like.

However, in view of strength of the overall hard drive base, such a pressed hard drive base may be inferior to a die-cast hard drive base according to the related art, such that there may be problems therewith.

Therefore, research into a technology of reinforcing strength of the base as described above is urgently required.

### SUMMARY

An aspect of the present disclosure may provide a base capable of reinforcing strength thereof by adding a reinforcement member to a pressed hard drive base of which strength may be weak.

According to an aspect of the present disclosure, abase may include: a base frame formed by plastic working of a steel sheet; a motor installation portion formed by depressing one portion of the base frame so that the depressed outer portion protrudes from a bottom surface of the base frame; and an additional reinforcement member provided on an outer side of a side wall surface of the motor installation portion protruding from the bottom surface of the base frame.

The additional reinforcement member may be continuously provided on the outer side of the side wall surface of the motor installation portion.

The additional reinforcement member may have a ring shape in which one side thereof is opened.

Opened both distal ends of the additional reinforcement member may be provided with a coupling assistance part extended in an outer diameter direction to assist in being coupled to the base frame.

An edge of the additional reinforcement member may be provided with a protrusion coupling part protruding downwardly in an axial direction so as to be closely coupled to an outer portion of the side wall surface forming the motor installation portion.

A plurality of coupling protrusion parts may be provided so as to be spaced apart from each other.

The additional reinforcement member may be formed of a metal or an alloy.

The additional reinforcement member may be formed integrally with the base frame by injection molding of the base frame using an outsert method.

The additional reinforcement member may be press-fitted or bonded to the outer side of the side wall surface of the motor installation portion.

The base may further include a reinforcement member provided in a shape corresponding to an inner edge of the motor installation portion and coupled to the motor installation portion along the inner edge thereof, wherein an edge of the reinforcement member is provided with a protrusion part upwardly in an axial direction so as to be closely coupled to an inner side of the side wall surface forming the motor installation portion.

The reinforcement member may be continuously provided along the inner edge of the motor installation portion.

One side of the reinforcement member may be opened.

The protrusion part may be continuously provided along an edge of the reinforcement member.

A plurality of protrusion parts may be provided along an edge of the reinforcement member so as to be spaced apart from each other.

The reinforcement member may be formed of a metal or an alloy.

The reinforcement member may be formed integrally with the base frame by injection molding of the base frame using an outsert method.

The reinforcement member may be press-fitted or bonded to an inner edge of the motor installation portion.

According to another aspect of the present disclosure, a hard disk drive may include: the base as described above; a spindle motor coupled to the motor installation portion of the base; and a head driver for moving a magnetic head.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic exploded perspective view illustrating a hard disk drive including a base according to an exemplary embodiment of the present disclosure;

FIG. 2 is a top perspective view illustrating a base of FIG. 1;

FIG. 3 is an enlarged view illustrating an enlarged motor installation portion of FIG. 2;

FIGS. 4 through 6 are perspective views illustrating examples of a reinforcement member according to an exemplary embodiment of the present disclosure;

FIG. 7 is a bottom perspective view of the base of FIG. 1;

FIG. 8 is a perspective view of an additional reinforcement member illustrated in FIG. 7;

FIG. 9 is a bottom perspective view of a base according to another exemplary embodiment of the present disclosure;

FIG. 10 is a perspective view of an additional reinforcement member illustrated in FIG. 9;

FIG. 11 is a bottom perspective view of a base according to another exemplary embodiment of the present disclosure; and

FIG. 12 is a perspective view of an additional reinforcement member illustrated in FIG. 11.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

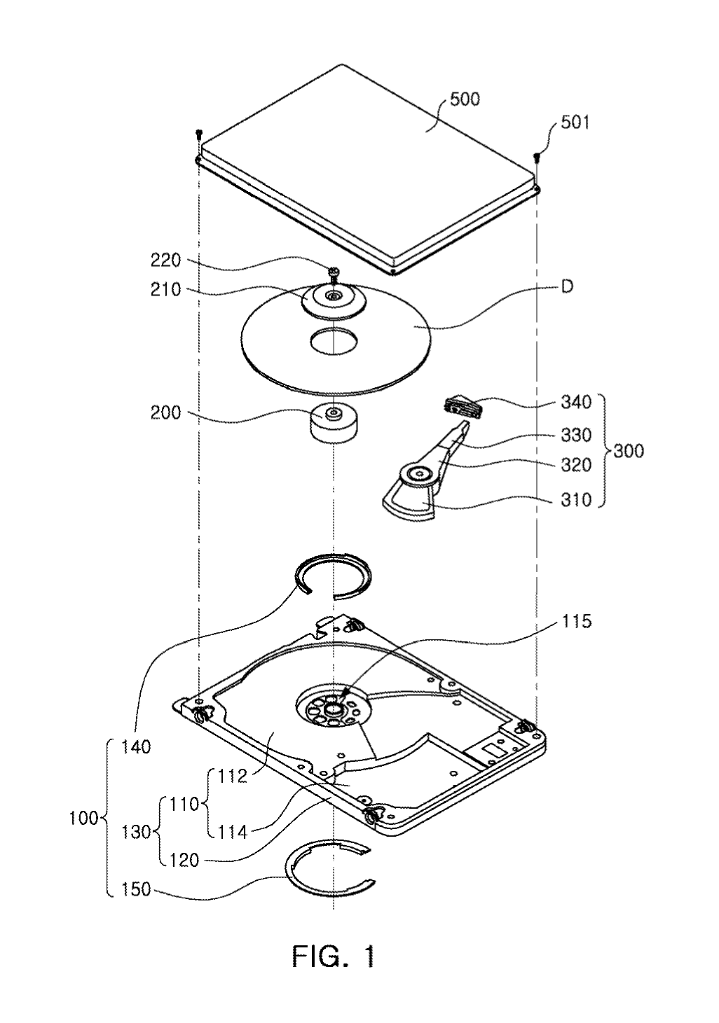

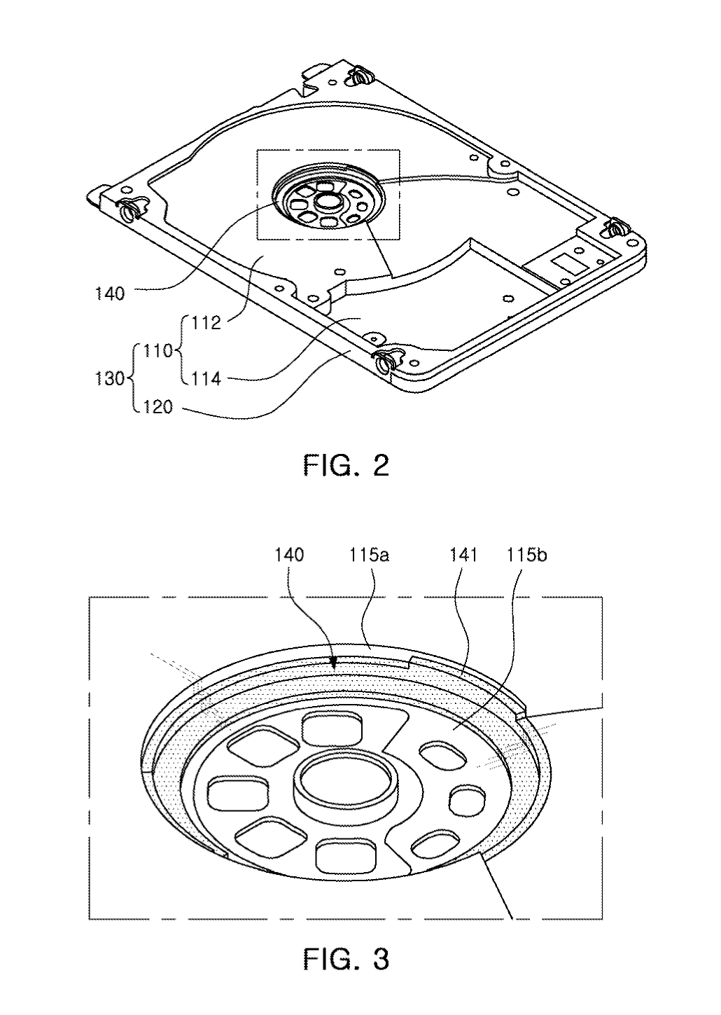

FIG. 1 is a schematic exploded perspective view illustrating a hard disk drive including a base according to an exemplary embodiment of the present disclosure, FIG. 2 is a top perspective view illustrating a base of FIG. 1, and FIG. 3 is an enlarged view illustrating an enlarged motor installation portion of FIG. 2.

Referring to FIG. 1, the hard disk drive 600 including the base 100 according to an exemplary embodiment of the present disclosure may include abase 100, spindle motor 200, and a head driver 300 for moving a magnetic head.

Terms with respect to directions will be first defined based on FIG. 1. An upward or downward direction in an axial direction refers to a direction from an upper surface of the base toward a cover 500 or a direction opposite thereto, and an inner diameter or outer diameter direction refers to a direction from an outer wall part 120 of the base 100 toward the center of a disk D or a direction opposite thereto.

The base 100 may be a housing forming an appearance together with the cover 500 in the hard disk drive 600 according to an exemplary embodiment of the present disclosure and include a base frame 130, a reinforcement member 140, and an additional reinforcement member 150.

In addition, the base 100 and the cover 500 may be coupled to each other by coupling a plurality of screws 501 to holes formed in the base 100.

Meanwhile, the base frame 130 may be formed by performing a plastic working process on a steel sheet and include a base body 110 and the outer wall part 120.

The base body 110 may be a part on which the disk D coupled to a spindle motor 200 to be described below is disposed and to which the head driver 300 is coupled.

More specifically, a partial region of the base body 110 may protrude downwardly in the axial direction to thereby configure a disk disposing part 112 and a head seating part 114.

The disk disposing part 112 may generally have a circular shape so as to correspond to a shape of the disk, and a surrounding part of one side of the disk disposing part 112 may be provided with the head seating part 114 to which the head driving part 300 reproducing the data stored in the disk D is coupled.

In addition, the motor installation portion 115 may be formed at an inner side of the disk disposing part 112. The motor installation portion 115 may be provided by depressing one portion of the disk disposing part 112. In this case, a depressed outer portion may protrude from a bottom surface of the base frame 130.

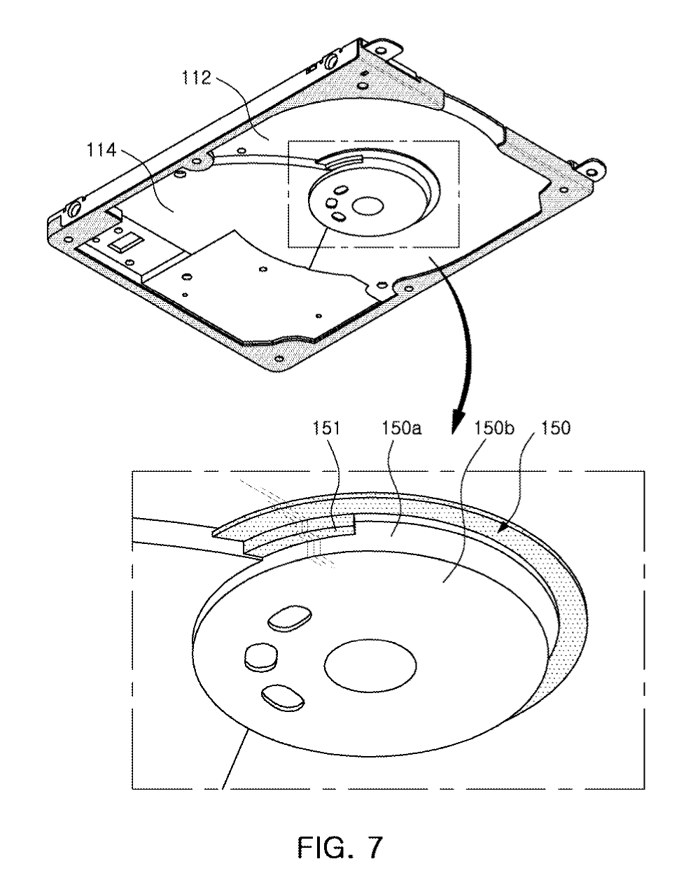

Further, the motor installation portion 115 may include a side wall surface 115a (see FIG. 7) and a bottom surface 115b (see FIG. 7), wherein inner and outer sides of the side wall surface 115a may be provided with a reinforcement member 140 and an additional reinforcement member 150 to be described below.

The outer wall part 120 may be formed on an outer side of the base body 110 to thereby define the outer side of the base body 110, and formed by bending an end portion of the base body 110.

Here, the base body 110 and the outer wall part 120 may be formed by a forging or pressing process and manufactured by disposing a plate shaped steel, which is a base material, that is, a cold rolled steel sheet (SPCC, SPCE, or the like), a hot rolled steel sheet, a stainless steel, or a lightweight alloy steel sheet such as a boron or magnesium alloy, or the like, in a press mold and pressing the plate shaped steel at a predetermined pressure. That is, the base body 110 and the outer wall part 120 may be formed by performing a plastic working process on the steel sheet.

In other words, a shape of an internal space formed by a combination of upper and lower molds for press or forging is implemented as a shape corresponding to those of the outer wall part 120 and the base body 110, whereby the base frame 130 according to an exemplary embodiment of the present disclosure may be manufactured by a single process.

However, after a basic shape of the base may be formed by a single pressing process, a final shape of the base frame 130 may be the formed by a bending process and an additional pressing process.

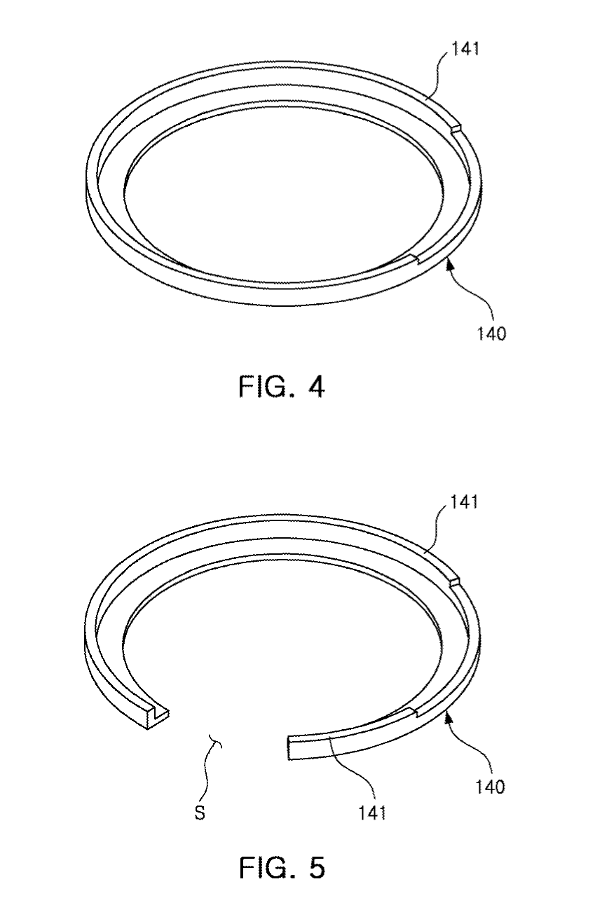

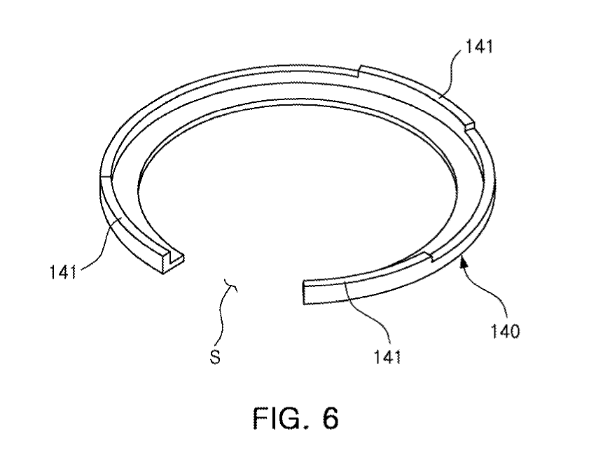

FIG. 3 is an enlarged view illustrating an enlarged motor installation portion of FIG. 2, and FIGS. 4 through 6 are perspective views illustrating examples of a reinforcement member 140 according to an exemplary embodiment of the present disclosure.

Referring to FIGS. 3 through 6, the reinforcement member 140 may be provided in a shape corresponding to an inner edge of the motor installation portion 115 to be coupled to the motor installation portion 115 along the inner edge thereof, wherein the shape corresponding to the inner edge of the motor installation portion 115 means an inner shape of the side wall surface 115a of the motor installation portion 115.

That is, the reinforcement member 140 may have an entirely round ring shape as illustrated in FIG. 4. However, the shape of the reinforcement member 140 is not necessarily limited thereto, but may be variously chanted so as to correspond to the inner shape of the motor installation portion 115. For example, in the case in which the motor installation portion 115 has a polygonal shape, the reinforcement member 140 may also have a polygonal outer shape so as to correspond to the shape of the motor installation portion 115.

Meanwhile, the reinforcement member 140 may be continuously provided along the inner edge of the motor installation portion 115 and include an open part S at which one side of the reinforcement member is opened so as to pass a printed circuit board (not shown) or a flexible printed circuit board (not shown).

Here, the printed circuit board or flexible printed circuit board is provided to control the driving, or the like, of the spindle motor 200 installed onto the motor installation portion 115, and one side of the reinforcement member 140 is opened, such that a space through which the boards may pass may be secured.

Therefore, a position of the open part S may be changed according to a position through which the printed circuit board or flexible printed circuit board passes.

In addition, although not shown in the accompanying drawings, the open part S may be disposed so as to correspond to a through hole (not shown) through which the printed circuit board or flexible printed circuit board of the base frame 130 passes.

Further, an edge of the reinforcement member 140 may be provided with a protrusion part 141 protruding upwardly in the axial direction so as to be closely coupled to the inner side of the side wall surface 115a forming the motor installation portion 115.

The protrusion part 141 may increase a contact area between the reinforcement member 140 and the motor installation portion 115 to improve coupling strength between the reinforcement member 140 and the motor installation portion 115.

Here, the protrusion part 141 may have a height equal to or lower than that of the disk disposing part 112, and the case in which the height of the protrusion part 141 is lower than that of the disk disposing part is illustrated in FIG. 3.

In addition, the protrusion part 141 may be continuously provided along the edge of the reinforcement member 140, or a plurality of protrusion parts 141 may be provided along the edge of the reinforcement member 140 so as to be spaced apart from each other.

Meanwhile, the reinforcement member 140 may be formed of a metal or an alloy and manufactured by a die-casting process using the metal or alloy. In addition, the reinforcement member 140 may be manufactured by disposing a steel sheet formed of the metal or alloy in a press mold and pressing the steel sheet at a predetermined pressure.

That is, the reinforcement member 140 may be manufactured separately from the base frame 130 to be coupled to the base frame 130 by a press-fitting method, a bonding method, or the like.

However, the present disclosure is not necessarily limited thereto, and the reinforcement member 140 may be formed by injection molding of the base frame 130 by an outsert method to thereby be formed integrally with the base frame 130.

The reinforcement member 140 as described above is coupled to the inner side of the motor installation portion 115, such that strength of the base frame 130 in the vicinity of the motor installation portion 115 may be strengthened.

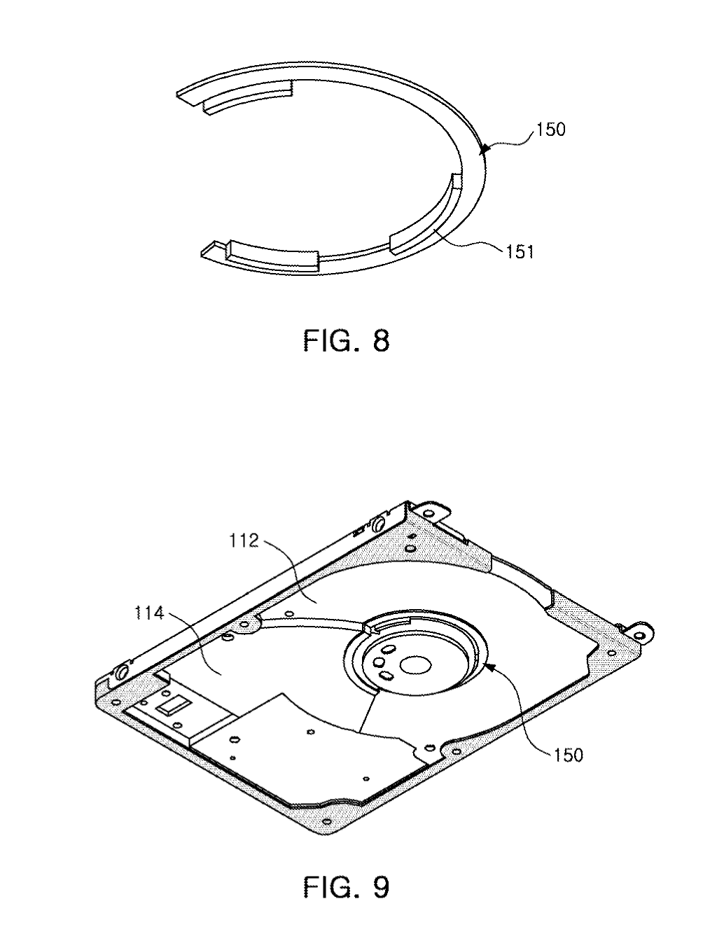

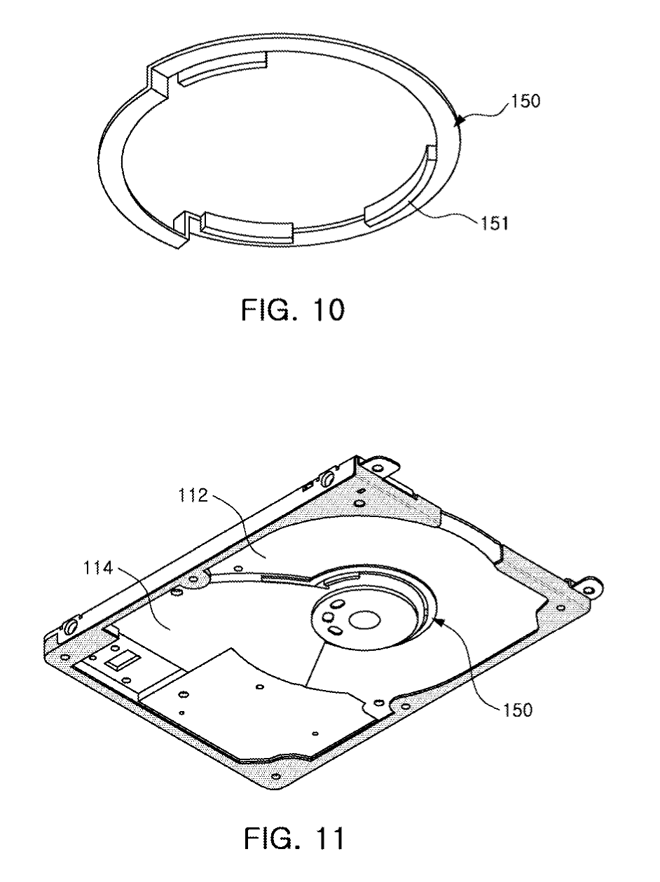

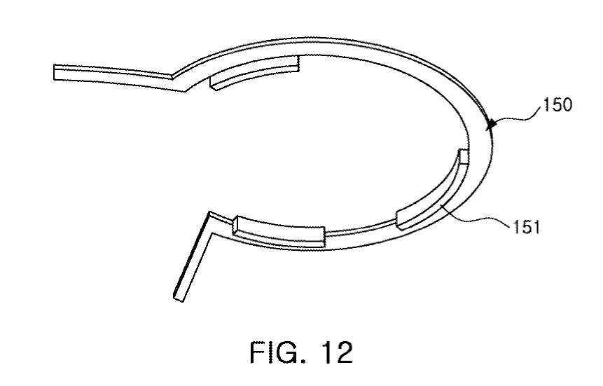

FIG. 7 is a bottom perspective view of the base of FIG. 1, FIG. 8 is a perspective view of an additional reinforcement member illustrated in FIG. 7, FIG. 9 is a bottom perspective view of a base according to another exemplary embodiment of the present disclosure, FIG. 10 is a perspective view of an additional reinforcement member illustrated in FIG. 9, FIG. 11 is a bottom perspective view of a base according to another exemplary embodiment of the present disclosure, and FIG. 12 is a perspective view of an additional reinforcement member illustrated in FIG. 11. Hereinafter, the additional reinforcement member provided in the base according to exemplary embodiments of the present disclosure will be described with reference to FIGS. 7 through 10.

The additional reinforcement member 150 may be provided on the outer side of the side wall surface 115a of the motor installation portion 115 protruding from the bottom surface of the base frame 130.

Here, the additional reinforcement member 150 may have a shape corresponding to an outer shape of the side wall surface 115a of the motor installation portion 115. That is, although the additional reinforcement member 150 having an entirely round ring shape is shown in the drawing, in the case in which the side wall surface 115a of the motor installation portion 115 has a polygonal shape, an inner shape of the additional reinforcement member 150 may also have a polygonal shape.

In addition, one side of the additional reinforcement member 150 may be opened as illustrated in FIG. 7, and an edge of the additional reinforcement member 150 may be provided with a protrusion coupling part 151 protruding downwardly in the axial direction so as to be closely coupled to the outer side of the side wall surface 115a.

The protrusion coupling part 151 may increase a contact area between the additional reinforcement member 150 and the motor installation portion 115 to improve coupling strength between the additional reinforcement member 150 and the motor installation portion 115.

Here, the protrusion coupling part 151 may have a height equal to or lower than that of the bottom surface 115b of the motor installation portion 115, and the case in which the protrusion coupling part 151 has a height lower than that of the bottom surface 115b is illustrated in FIG. 7.

In addition, a plurality of coupling protrusion parts 151 may be provided along an edge of the additional reinforcement member 150 so as to be spaced apart from each other.

Meanwhile, the additional reinforcement member 150 may be formed of a metal or an alloy and manufactured by a die-casting process using the metal or alloy. In addition, the additional reinforcement member 150 may be manufactured by disposing a steel sheet formed of the metal or alloy in a press mold and pressing the steel sheet at a predetermined pressure.

That is, the additional reinforcement member 150 may be manufactured separately from the base frame 130 to be coupled to the base frame 130 by a press-fitting method, a bonding method, or the like.

However, the present disclosure is not necessarily limited thereto, and the additional reinforcement member 150 may be formed by injection molding of the base frame 130 by an outsert method to thereby be formed integrally with the base frame 130.

The additional reinforcement member 150 as described above is coupled to the outer side of the motor installation portion 115, such that strength of the base frame 130 in the vicinity of the motor installation portion 115 may be strengthened.

Various examples of the additional reinforcement member 150 as described above are illustrated in FIGS. 9 through 12, and other features of the additional reinforcement member 150 except for an appearance thereof are the same as those of the additional reinforcement member 150 illustrated in FIGS. 7 and 8. Therefore, a detailed description of the same configurations will be omitted and be replaced with the above-mentioned description.

Referring to FIGS. 9 and 10, the additional reinforcement member 150 may have a continuous ring shape. Therefore, the additional reinforcement member 150 may be continuously provided on the outer side of the side wall surface 115a of the motor installation portion 115.

In addition, referring to FIGS. 11 and 12, the additional reinforcement member 150 may have a ring shape in which one side thereof is opened. In this case, both opened distal ends may be provided with a coupling assistance part 152 extended in the outer diameter direction to thereby assist in being coupled to the base frame 130.

Meanwhile, except for the exemplary embodiments described above, various modifications may be suggested by those skilled in the art to which the present disclosure pertains from this description without departing form the scope and sprit of the present disclosure. Accordingly, such modifications should also be understood to fall within the scope of the present disclosure.

The spindle motor 200, which is to rotate the disk D, may be fixedly mounted at a central portion of the motor installation portion 115. The disk D, which is coupled to the spindle motor 200 to thereby rotate together with the spindle motor 200, may have a writing surface on which data is written.

Here, the spindle motor 200 may include a clamp 210 coupled to an upper end portion thereof by a screw 220 in order to firmly fix the disk D thereto.

In addition, although FIG. 1 shows a configuration in which a single disk D is mounted on the spindle motor 200, this configuration is only an example. That is, one or more disk D may be mounted on the spindle motor 200. In the case in which a plurality of disks D are mounted as described above, a ring shaped spacer for maintaining an interval between the disks D may be disposed between the disks D.

The head driver 300 may be called a head stack assembly (HSA) and be a component having a magnetic head (not shown) mounted thereon and moving the magnetic head (not shown) to a predetermined position to write data on the disk D or read the data written on the disk D.

The head driver 300 may include a voice coil motor (VCM) 310, a swing arm 320, and a suspension 330, wherein the suspension 330 may be fixedly coupled to a front end portion of the swing arm 320.

In addition, the head driver 300 may be coupled to the base 100 so as to be rotatable around a pivot axis of the base 100. When the disk D rotates on the disk disposing part 112 of the base body 110 at a high speed, the magnetic head (not shown) serves to reproduce the data written on the writing surface of the disk D or write the data on the writing surface of the disk D.

Here, the VCM 310, which is a component providing rotational driving force to the head driver 300, may include magnets disposed at upper and lower portions of a VCM coil of the head driver 300.

The VCM 310 may be controlled by a servo control system and rotate the head driver 300 around the pivot axis in a direction according to Fleming's left hand rule by interaction between current input by the VCM coil and a magnetic field formed by the magnet.

Here, when an operation start command is input to the hard disk drive 600 according to an exemplary embodiment of the present disclosure, the disk D starts to rotate, and the VCM 310 rotates the swing arm 320 in a counterclockwise direction to thereby move the magnetic head (not shown) onto the writing surface of the disk D.

On the other hand, when an operation stop command is input to the hard disk drive 600 according to an exemplary embodiment of the present disclosure, the VCM 310 rotates the swing arm 320 in a clockwise direction to thereby allow the magnetic head (not shown) to deviate from the disk D.

The magnetic head (not shown) deviating from the writing surface of the disk D is parked in a ramp 340 provided outside the disk D.

As set forth above, according to exemplary embodiments of the present disclosure, the base having sufficient strength while using the pressed hard drive base, and the hard disk drive including the same may be provided.

While exemplary embodiments have been shown and described above, it will be apparent to those skilled in the art that modifications and variations could be made without departing from the spirit and scope of the present disclosure as defined by the appended claims.

What is claimed is:

1. A base comprising:
a base frame formed by plastic working of a steel sheet;
a motor installation portion formed by depressing one portion of the base frame so that the depressed outer portion protrudes from a bottom surface of the base frame; and
an additional reinforcement member provided on an outer side of a side wall surface of the motor installation portion protruding from the bottom surface of the base frame.

2. The base of claim 1, wherein the additional reinforcement member is continuously provided on the outer side of the side wall surface of the motor installation portion.

3. The base of claim 1, wherein the additional reinforcement member has a ring shape in which one side thereof is opened.

4. The base of claim 3, wherein opened both distal ends of the additional reinforcement member are provided with a coupling assistance part extended in an outer diameter direction to assist in being coupled to the base frame.

5. The base of claim 1, wherein an edge of the additional reinforcement member is provided with a protrusion coupling part protruding downwardly in an axial direction so as to be closely coupled to the outer side of the side wall surface forming the motor installation portion.

6. The base of claim 5, wherein a plurality of coupling protrusion parts are provided so as to be spaced apart from each other.

7. The base of claim 1, wherein the additional reinforcement member is formed of a metal or an alloy.

8. The base of claim 1, wherein the additional reinforcement member is formed integrally with the base frame by injection molding of the base frame using an outsert method.

9. The base of claim 1, wherein the additional reinforcement member is press-fitted or bonded to the outer side of the side wall surface of the motor installation portion.

10. The base of claim 1, further comprising a reinforcement member provided in a shape corresponding to an inner edge of the motor installation portion and coupled to the motor installation portion along the inner edge thereof,
wherein an edge of the reinforcement member is provided with a protrusion part upwardly in an axial direction so as to be closely coupled to an inner side of the side wall surface forming the motor installation portion.

11. The base of claim 10, wherein the reinforcement member is continuously provided along the inner edge of the motor installation portion.

12. The base of claim 10, wherein one side of the reinforcement member is opened.

13. The base of claim 10, wherein the protrusion part is continuously provided along an edge of the reinforcement member.

14. The base of claim 10, wherein a plurality of protrusion parts are provided along an edge of the reinforcement member so as to be spaced apart from each other.

15. The base of claim 10, wherein the reinforcement member is formed of a metal or an alloy.

16. The base of claim 10, wherein the reinforcement member is formed integrally with the base frame by injection molding of the base frame using an outsert method.

17. The base of claim 10, wherein the reinforcement member is press-fitted or bonded to an inner edge of the motor installation portion.

18. A base comprising:
a base frame formed by plastic working of a steel sheet;
a motor installation portion formed by depressing one portion of the base frame so that the depressed outer portion protrudes from a bottom surface of the base frame; and
a reinforcement member provided in a shape corresponding to an inner edge of the motor installation portion and coupled to the motor installation portion along the inner edge thereof,
wherein an edge of the reinforcement member is provided with a protrusion part protruding upwardly in an axial direction so as to be closely coupled to an inner side of a side wall surface forming the motor installation portion.

19. A hard disk drive comprising:
the base of claim 1;
a spindle motor coupled to the motor installation portion of the base; and
a head driver for moving a magnetic head.

20. A hard disk drive comprising:
the base of claim 18;
a spindle motor coupled to the motor installation portion of the base; and
a head driver for moving a magnetic head.
